(19) United States
(12) Patent Application Publication
(10) Pub. No.: US 2023/0330861 A1
(43) Pub. Date: Oct. 19, 2023

(54) ROBOT DEVICE AND INFORMATION PROCESSING DEVICE

(71) Applicant: SONY GROUP CORPORATION, TOKYO (JP)

(72) Inventors: ICHITARO KOHARA, TOKYO (JP); ATSUSHI ISHIHARA, TOKYO (JP); RYO YOSHIZAWA, TOKYO (JP)

(21) Appl. No.: 18/245,350

(22) PCT Filed: Aug. 17, 2021
(86) PCT No.: PCT/JP2021/030063

§ 371 Date: Mar. 15, 2023

(30) Foreign Application Priority Data
Sep. 28, 2020 (JP) 2020-162193

(51) Int. Cl. B25J 11/00; B25J 9/00; B25J 9/16

(52) U.S. Cl. CPC B25J 11/001; B25J 9/0003; B25J 9/161

(57) ABSTRACT

A robot device according to an embodiment of the present disclosure includes: an input acceptor configured to accept an input to a robot device; an expression content decider configured to decide a set of expression contents in which the expression contents are associated with each other, the expression contents each indicating a response of the robot device with respect to the input; and the signal generator configured to generate an instruction signal that causes another device other than the robot device to execute an operation corresponding to one portion out of the set of expression contents.

### TECHNICAL FIELD

The present disclosure relates to a robot device and an information processing device.

### BACKGROUND ART

There has been a technique related to a robot device that is able to interact with a user, and that detects an utterance made by the user and controls a facial expression of the robot device in response to the utterance (PTL 1).

### CITATION LIST

### Patent Literature

PTL 1: Japanese Unexamined Patent Application Publication No. 2006-289508

### SUMMARY OF THE INVENTION

The technique of PTL 1 is considered to be preferable for application to a humanoid robot, and describes that control on a facial expression encourages a user to recognize that an utterance made by the user is detected by a robot device or that the robot device is making an utterance as a response to the utterance made by the user.

However, an expression made by the robot device is often boring. It is not always possible to add a function dedicated to the expression to the robot device in order to expand an expressible range, due to restrictions on size and cost.

Accordingly, it is desirable to provide a robot device and an information processing device that are each able to appropriately make a response expression to an input.

A robot device according to an embodiment of the present disclosure includes: an input acceptor configured to accept an input to a robot device; an expression content decider configured to decide a set of expression contents in which the expression contents are associated with each other, the expression contents each indicating a response of the robot device with respect to the input; and the signal generator configured to generate an instruction signal that causes another device other than the robot device to execute an operation corresponding to one portion out of the set of expression contents.

An information processing device according to an embodiment of the present disclosure includes: an input acceptor configured to accept an input to a robot device; an expression content decider configured to decide a set of expression contents in which the expression contents are associated with each other, the expression contents each indicating a response with respect to the input; the signal generator configured to generate an instruction signal that causes another device other than the robot device to execute an operation corresponding to one portion out of the set of expression contents; and an operation control unit configured to generate a control signal that causes the robot device to execute an operation corresponding to another portion out of the set of expression contents other than the one portion.

### BRIEF DESCRIPTION OF DRAWINGS

FIG. 1 is a schematic diagram illustrating a configuration of a robot device according to a first embodiment of the present disclosure, and illustrates a relationship with other devices cooperable with the robot device.

FIG. 2 is a schematic diagram illustrating a configuration of a control system of the robot device according to the embodiment

FIG. 3 is a flowchart illustrating a basic operation of the control system according to the embodiment.

FIG. 4 is a flowchart illustrating specific contents of S106 (an expression content generation process) in the flowchart illustrated in FIG. 3.

FIG. 5 is a schematic diagram illustrating a configuration of a robot device according to a second embodiment of the present disclosure, and illustrates a relationship with other devices cooperable with the robot device.

FIG. 6 is a flowchart illustrating a basic operation of a control system of the robot device according to the embodiment.

FIG. 7 is a schematic diagram illustrating a configuration of a robot device according to a third embodiment of the present disclosure, and illustrates a relationship with other devices cooperable with the robot device.

### MODES FOR CARRYING OUT THE INVENTION

The following describes embodiments of the present disclosure in detail with reference to the drawings. The following description is a specific example of the present disclosure, but the present disclosure is not limited to the following embodiments. In addition, the present disclosure is not limited to arrangement, dimensions, dimensional ratios, and the like of the constituent elements illustrated in the drawings.

Description is given in the following order.
1. First Embodiment
1.1. Configuration of Robot Device
1.2. Configuration of Control System
1.3. Basic Operation of Robot Device
1.4. Explanation Using Flowchart
1.5. Action and Effects
2. Second Embodiment
3. Third Embodiment
4. Conclusion

### 1. FIRST EMBODIMENT

### (1.1. Configuration of Robot Device)

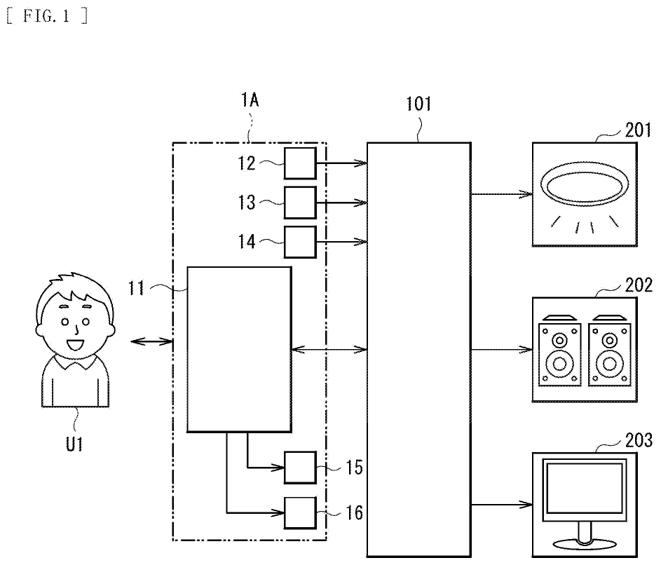

FIG. 1 is a schematic diagram illustrating a configuration of a robot device 1A according to a first embodiment of the present disclosure, and illustrates a relationship with other devices 201 to 203 cooperable with the robot device 1A.

In the present embodiment, the robot device 1A has a function of interpreting a content of an utterance made by a user U1, and is able to interact with the user U1 through a dialogue. The robot device 1A may be stationary or may be mobile. In a case where the robot device 1A is a mobile robot device, it is possible that the robot device 1A may be provided with wheels or legs. As the robot device 1A with wheels, a vehicle robot device may be given as an example. As the robot device 1A with legs, a biometric robot device may be given as an example. For the robot device 1A of an installation type, an attitude or an orientation may be made variable by, for example, providing a joint, to thereby obtain diversification in expression by the robot device 1A itself.

The robot device 1A includes a robot body 11. The robot device 1A also includes: a microphone 12, a camera 13, and various types of sensors 14, each serving as an input unit; and a speaker 15 and a light source 16 each serving as an output unit. Components that configure the input unit and components that configure the output unit are not limited to these specific examples. The input unit detects an action performed by the user U1 on the robot device 1A and the output unit outputs a response of the robot device 1A with respect to the action performed by the user U1. In the present embodiment, the input unit is able to detect auditory, visual, and tactile actions, and the output unit is able to auditorily and visually output a response to the actions. The action performed by the user U1 corresponds to an “input to the robot device” according to the present embodiment.

The robot body 11 is recognized by the user U1 as a partner of an interaction. The robot body 11 includes a housing in which input units including, for example, the microphone 12, and output units including, for example, the speaker 15, which are to be described below, are installed, and incorporates a calculation unit that executes a predetermined calculation and a communication unit that communicates with a control system 101.

The microphone 12 detects an auditory action performed by the user U1, for example, an utterance of the user U1.

The camera 13 detects a visual action performed by the user U1, for example, a facial expression of the user U1.

The various types of sensors 14 detects a tactile action performed by the user U1, for example, touching of the user U1 to the robot body 11. Examples of employable sensor 14 may include a contact sensor.

The speaker 15 outputs auditorily, e.g., outputs by a voice, a response to the action performed by the user U1.

The light source 16 outputs visually, e.g., outputs by varying a blinking pattern or a color of light, a response to the action performed by the user U1. In the present embodiment, an LED light source that is able to emit one or more colors is employed as the light source 16; however, the light source 16 is not limited thereto, and may be a configured to display an image. Examples of the light source 16 in this case may include a display that is able to display an image representing a form of an organ (e.g., an eye) of a human or another living body.

The robot device 1A is communicably coupled to the control system 101, transmits information detected by the input unit such as the microphone 12 to the control system 101, receives a control signal from the control system 101, and operates in accordance with an instruction indicated by the control signal. The operation corresponding to the instruction from the control system 101 includes operations performed by the robot device 1A through the speaker 15 and the light source 16.

The control system 101 receives the information transmitted by the robot device 1A and, on the basis of the information, decides a set of expression contents each indicating a response of the robot device 1A with respect to the action performed by the user U1, that is, with respect to the input performed by the user U1. In the present embodiment, the set of expression contents includes both a content to be expressed as an operation of the robot device 1A itself and a content to be expressed as an operation of another device (hereinafter may be referred to as a “cooperating device”) that is configured to be cooperable with the robot device 1A. The auditory expression performed by the speaker 15 and the visual expression performed by the light source 16 described above each correspond to expressions made by the robot device 1A itself.

The control system 101 generates a control or instruction signal for the robot device 1A and the cooperating devices 201 to 203 on the basis of the decided expression content, and outputs the control or instruction signal. The present embodiment employs a lighting device 201, an acoustic device 202, and a display device 203 as cooperating devices. In a case where the robot device 1A is used in a home, examples of devices employable as the lighting device 201 may include a ceiling lamp in a room in which the robot device 1A is installed or in a room other than the room in which the robot device 1A is installed. In addition, examples of the acoustic device 202 may include an audio speaker, and examples of the display device 203 include a display of a television set or a personal computer. In the present embodiment, the acoustic device 202 and the display device 203 are implemented by separate devices; however, respective functions of the acoustic device 202 and the display device 203 may also be integrated into a single device. Examples of other devices in this case include a smartphone and a tablet computer.

The lighting device 201, the acoustic device 202, and the display device 203 each operate in accordance with the instruction indicated by the control signal outputted from the control system 101, and express, out of the set of expression contents decided by the control system 101, a content other than a content that the robot device 1A is to perform.

### (1.2. Configuration of Control System)

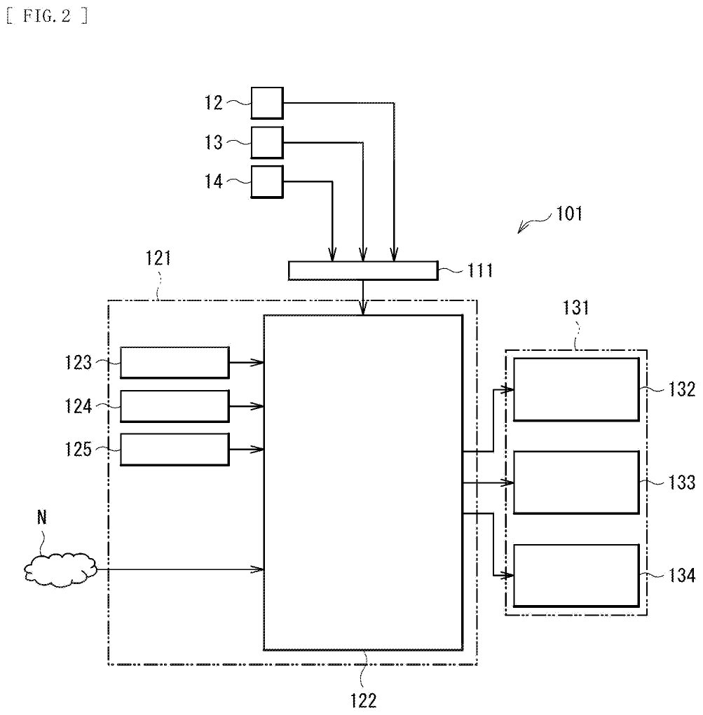

FIG. 2 is a schematic diagram illustrating a configuration of the control system 101 of the robot device 1A according to the present embodiment.

The control system 101 may be built into the body 11 of the robot device 1A or may be installed at a place other than the robot device 1A. In the former case, the control system 101 may be implemented by a microcomputer included in the robot device 1A, and the robot device 1A includes a storage that stores in advance a computer program including a command that causes the microcomputer to operate as the control system 101. In contrast, in the latter case, the control system 101 may be implemented by a server computer located at a place away from the robot device 1A. The robot device 1A and the control system 101 may be configured to communicate with each other via wire or wirelessly. FIG. 2 illustrates an example of a case where the control system 101 is implemented by a server computer. The control system 101 is placed in a so-called cloud, and is coupled to the robot device 1A via a network N such as the Internet. The control system 101 and the robot device 1A are communicable with each other.

The control system 101 includes an input acceptor 111, an expression content decider 121, and a signal generator 131.

The input acceptor 111 is configured to accept an input to the robot device 1A. In the present embodiment, the input acceptor 111 is implemented as an input port of the server computer and receives a detection signal from the input unit such as the microphone 12 of the robot device 1A. Thus, the input acceptor 111 is able to acquire an index indicating the action of the user U1 with respect to the robot device 1A.

The expression content decider 121 is configured to decide the set of expression contents each indicating the response of the robot device 1A with respect to the action performed by the user U1, that is, with respect to the input performed by the user U1. The expression contents in the set are associated with each other, and may each include representing an emotion that the robot device 1A holds (an emotion of the robot device 1A) with respect to the input performed by the user U1 or reflecting an emotion of the user U1 that the robot device 1A grasps via the input performed by the user U1.

In this way, the present embodiment decides the expression content as the response to the input performed by the user U1; however, the expression content is not limited thereto, and may also be decided as a response to an input made through a path other than the interaction between the robot device 1A and the user U1. By way of example, the expression contents in the set may be associated with each other, each serving to present a situation in which the user U1 is in, and the control system 101 may obtain the input via the network N. Examples of employable input in this case may include an alarm such as an earthquake early warning.

The expression content decider 121 includes a learning calculation unit 122, and also includes an operation mode setting unit 123, a user attribute identification unit 124, and a user situation determination unit 125.

The learning calculation unit 122 has a machine-learning function, and decides the set of expression contents on the basis of the input (e.g., the detection signal from the microphone 12) acquired by the robot device 1A via the interaction with the user U1 and the input (e.g., the earthquake early warning) acquired by the robot device 1A through a path other than the interaction with the user 1.

The operation mode setting unit 123 sets an operation mode of the robot device 1A. In the present embodiment, a plurality of operation modes are set, and the plurality of operation mode may be switched on the basis of selection or preference of the user U1. In the present embodiment, as the operation mode of the robot device 1A, an operation mode representing an emotion or a character to be given to the robot device 1A is set.

The user attribute identification unit 124 identifies an attribute of the user U1. The attribute to be identified is, for example, the sex or a character of the user U1.

The user situation determination unit 125 determines a situation in which the user U1 is in. For example, on the basis of the earthquake early warning, the user situation determination unit 125 determines that there is the potential for an earthquake of an alarming seismic intensity may occur in a place at which the user U1 is present.

Upon deciding the expression content, the learning calculation unit 122 may change specific contents on the basis of the operation mode of the robot device 1A, the attribute of the user U1 (hereinafter, may be referred to as a “user attribute”), and the situation in which the user U1 is in (hereinafter, may be referred to as a “user situation”).

The signal generator 131 generates a control signal that causes another device other than the robot device 1A, that is, any of the cooperating devices 201 to 203, to execute an operation corresponding to one portion out of the set of expression contents. In addition, the signal generator 131 generates a control signal that causes the robot device 1A to execute an operation corresponding to another portion out of the set of expression contents other than the one portion. In other words, the signal generator 131 causes the response of the robot device 1A with respect to the input performed by the user U1 to be expressed not only by the robot device 1A, but also by the robot device 1A and the other devices 201 to 203 in cooperation with each other.

The signal generator 131 includes a dialogue generation unit 132, a body expression generation unit 133, and a cooperating expression generation unit 134.

The dialogue generation unit 132 generates a control signal for, out of the set of expression contents, causing the robot device 1A to make an utterance as the response with respect to the input.

The body expression generation unit 133 generates a control signal for, out of the set of expression contents, causing the robot device 1A to execute an operation involving a variation in an attitude, an orientation, or a position of the robot device 1A itself, as the response with respect to the input.

The cooperating expression generation unit 134 generates a control signal for, out of the set of expression contents, causing the cooperating devices 201 to 203 to execute a predetermined operation as the response with respect to the input. In contrast, the lighting device 201 may repeatedly flash in a predetermined pattern, the acoustic device 202 may play a predetermined music, and the display device 203 may display a message set in advance.

The input acceptor 111 corresponds to an “input acceptor” according to the present embodiment, the expression content decider 121 corresponds to an “expression content decider” according to the present embodiment, and the signal generator 131 corresponds to a “signal generator” according to the present embodiment. The dialogue generation unit 132 and the body expression generation unit 133 correspond to an “operation control unit” according to the present embodiment, where the “operation control unit” is incorporated into the “signal generator” in the present embodiment. Further, the operation mode setting unit 123 included in the expression content decider 121 corresponds to an “operation mode setting unit” according to the present embodiment, and the user attribute identification unit 124 included in the expression content decider 121 corresponds to a “user attribute identification unit” according to the present embodiment.

### (1.3. Basic Operation of Robot Device)

The robot device 1A operates in cooperation with the other devices 201 to 203 on the basis of the set of expression contents each indicating the response of the robot device 1A with respect to the action performed by the user U1, that is, with respect to the input performed by the user U1. Here, the robot device 1A performs an operation of representing the emotion that the robot device 1A holds with respect to the input performed by the user U1 or performs an operation reflecting the emotion of the user U1 that the robot device 1A grasps via the input performed by the user U1, and also performs an operation of encouraging the user U1 to recognize by himself/herself the situation in which the user U1 is in. Here, in the robot device 1A, the operation mode, the user attribute, and the user situation of the robot device 1A are referred to by the control system 101 upon deciding a specific expression content. As a result, the robot device 1A may make different responses or operations with respect to a single action performed by the user U1.

In a case where the robot device 1A performs the operation of representing the emotion that the robot device 1A holds (the emotion of the robot device 1A) with respect to the input performed by the user U1, examples of an operation of representing a happy emotion include: making the utterance “Great!” via the speaker 15 of the robot device 1A; and brightening illumination via the lighting device 201, and playing back joyful music via the acoustic device 202. Further, examples of an operation of representing a sad emotion by the robot device A1 include making the utterance “Sob . . . ”, darkening the illumination, and playing back sad music, and examples of an operating representing an angry emotion include making the utterance “I don't care anymore!” and stopping operations of all cooperating devices 201 to 203 including the lighting device 201.

In a case where the robot device 1A performs the operation reflecting the emotion of the user U1 that the robot device 1A grasps via the input performed by the user U1, examples of an operation reflecting the happy emotion include making the utterance “Is anything good happened? Tell me!” via the speaker 15 of the robot device 1A and playing back a sound source of drum roll via the acoustic device 202, and examples of an operation reflecting the sad emotion include making the utterance “Cheer up!”, brightening illumination via the lighting device 201, and playing back music of the artist that the user U1 likes via the acoustic device 202.

In a case where the robot device 1A performs the operation of encouraging the user U1 to recognize by himself/herself the situation in which the user U1 is in, examples of an operation of encouraging the user U1 to recognize that there is the potential for an earthquake of an alarming seismic intensity may occur include: making the utterance “Watch out, earthquake!” via the speaker 15 of the robot device 1A while repeating busy movement; playing back the voice “Hide beneath the desk” via the acoustic device 202; and displaying the message “Earthquake early warning received” via the display device 203. Further, examples of an operation of encouraging the user U1 to recognize that the user U1 is staying up late at night include making the utterance “Let's go to sleep, school tomorrow”, darkening the illumination, and playing back music that induces sleep, and examples of an operation of encouraging the user U1 to recognize that a child have a temperature include making the utterance “XX (name of the child) may be sick . . . ” and blinking the illumination.

Further, for example, in a case where the robot device 1A performs the operation of representing the emotion of the robot device 1A, the robot device 1A is able to change specific contents of the utterance on the basis of whether the robot device 1A is in the operation mode of “cute” or in the operation mode of “baby”. Moreover, in a case where the robot device 1A performs the operation reflecting the emotion of the user U1, the robot device 1A is able to change specific contents of the utterance on the basis of whether the user U1 is a male or a female, and in a case where the operation of encouraging the user U1 to recognize by himself/herself the situation, the robot device 1A is able to provide the user U1 having a visual disability with an expression focused on the utterance rather than the message, and to provide the user U1 having a hearing disability with an expression focused on the message rather than the utterance.

### (1.4. Explanation Using Flowchart)

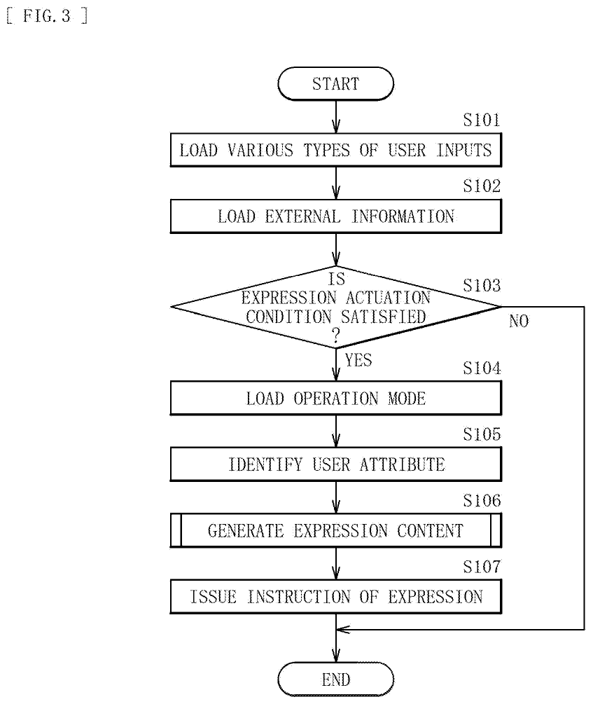

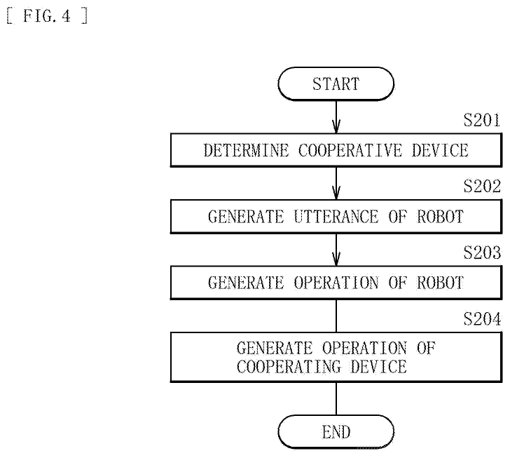

FIG. 3 is a flowchart illustrating a basic operation of the control system 101 according to the present embodiment, and FIG. 4 is a flowchart illustrating specific contents of S106 (an expression content generation process) in the flowchart illustrated in FIG. 3.

In the present embodiment, a control routine illustrated in the flowchart of FIG. 3 is executed by the control system 101 for every predetermined time during power supply to the robot device 1A, and the process illustrated in the flowchart of FIG. 4 is executed as a subroutine of the control routine by the control system 101

In S101, various types of user inputs are loaded. In the present embodiment, detection signals of the microphone 12, the camera 13, and the various types of sensors 14 are each loaded as the user input.

In S102, external information is loaded. The loading of the external information is performable via the network N, for example. The external information includes an alarm such as the earthquake early warning (i.e., the user situation).

In S103, whether or not an expression actuation condition is satisfied is determined. If the expression actuation condition is satisfied, the process proceeds to S104, and if the expression actuation condition is not satisfied, the control in this routine is terminated.

In S104, the operation mode of the robot device 1A is loaded.

In S105, the attribute of the user U1 (the user attribute) is identified.

Here, as the user attribute, the emotion of the user U1 may be grasped as follows: a voice detected by the microphone 12 is subjected to a voice recognition process and a natural language processing to thereby identify delight, anger, sorrow, and pleasure of the user U1; the voice detected by the microphone 12 is subjected to a process (a process making use of a neural network or a process making use of feature amount extraction) to thereby identify the delight, anger, sorrow, and pleasure of the user U1 on the basis of a tone of the voice; and an image detected by the camera 13 is subjected to a process (a process making use of the neural network or a process making use of the feature amount extraction) to thereby identify the delight, anger, sorrow, and pleasure of the user U1 on the basis of a facial expression.

In S106, the set of expression contents is decided.

In deciding the expression content, an emotion that the robot device 1A is to hold may be determine as follows. If a contact sensor 14 detects that the robot device 1A is being stroked, the robot device 1A is determined to be in a happy emotion, or if the microphone 12 detects that the robot device 1A is being scolded on the basis of a tone of an utterance made by the user U1, the robot device 1A is determined to be in a sad emotion.

In S107, a control signal corresponding to the decided expression content is generated, and the robot device 1A and the cooperating devices 201 to 203 are each instructed to express a response.

Moving to the flowchart illustrated in FIG. 4, in S201, cooperable other devices 201 to 203 are determined on the basis of the expression content.

In S202, as a portion of the expression content, a content of an utterance to be performed by the robot device 1A itself is generated.

In S203, as another portion of the expression content, an operation to be performed by the robot device 1A itself is generated.

In S204, as still another portion of the expression content, an operation to be performed by the cooperating devices 201 to 203 is generated.

The specific contents of the operations to be generated by the processes of S202 to 204 are as described in the explanation of the basic operation of the robot device 1A.

### (1.5. Action and Effects)

There has been a technique related to a robot device that is able to interact with a user, and that detects an utterance made by the user and controls a facial expression of the robot device in response to the utterance. PTL 1 described above discloses the following as a technique that is preferable for application to a humanoid robot. The control on the facial expression encourages the user to recognize that the utterance made by the user is detected by the robot device or that the robot device is making an utterance as a response to the utterance made by the user.

However, an expression made by the robot device is often boring. Basically, functions provided in the robot device itself are used or diverted. Thus, there are expressible range limitations corresponding to those functions. It is possible to promote an expansion of an expressible range by adding a function dedicated to the expression to the robot device; however, it is not always possible due to restrictions on size and cost. Such an issue is particularly noticeable in consumer products.

In contrast, the present embodiment accepts an input to the robot device 1A, and decides a set of expression contents in which the expression contents are associated with each other and each indicate a response to the robot device 1A with respect to the input. Further, the present embodiment causes other devices, i.e., cooperating devices 201 to 203, other than the robot device 1A to execute an operation corresponding to one portion out of the set of expression contents, and causes the robot device 1A to execute an operation corresponding to another portion out of the set of expression contents.

As described above, the expression of the response with respect to the input is executable via the other devices other than the robot device 1A, which makes it possible to perform the expression in excess of the expressible range by the robot device 1A itself, that is, to perform the expression beyond limits of functions provided in the robot device 1A itself. As a result, it becomes possible that the response expression be appropriately made by the robot device 1A, and it is possible to improve an influence on a user experience (UX).

In addition, in the present embodiment, the operation corresponding to the one portion out of the set of expression contents is also performed by the robot device 1A itself. Thus, it is possible to execute the response expression to the input by the robot device 1A and the other devices 201 to 203 in cooperation with each other, and to appropriately perform the response expression, and it is also possible to encourage the user U1 to recognize that the expression is made as a response to the input performed by the user U1.

### 2. SECOND EMBODIMENT

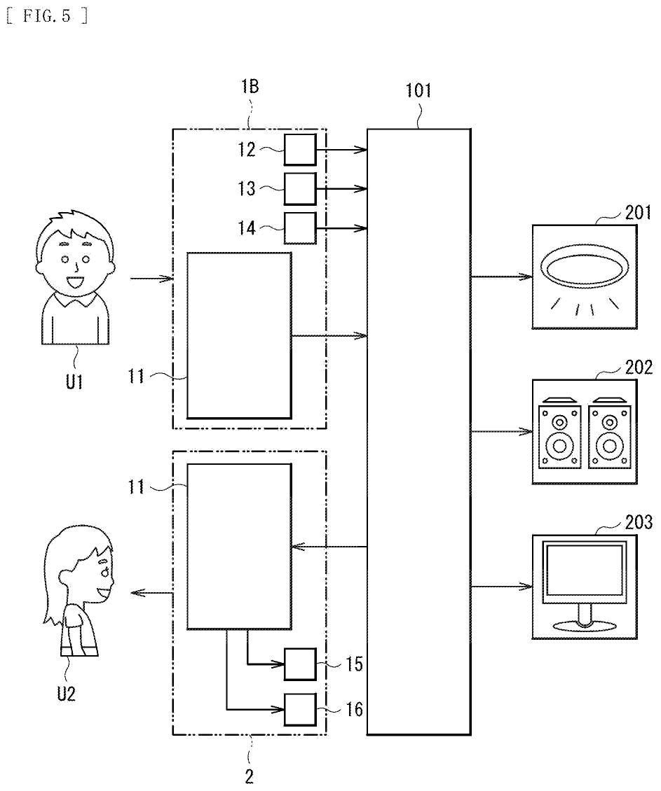

FIG. 5 is a schematic diagram illustrating a configuration of a robot device 1B according to a second embodiment of the present disclosure, and illustrates a relationship with other devices 2 and 201 to 203 cooperable with the robot device 1B.

The present embodiment employs the robot device 2 that is able to interact with a user U2 through a dialogue, in addition to the lighting device 201, the acoustic device 202, and the display device 203 each serving as a cooperating device that is another device other than the robot device 1B. The robot device 1B that the user (hereinafter, may be particularly referred to as “transmission user”) U1 faces and the robot device (hereinafter, may be particularly referred to as “cooperating robot device”) 2 that the user (hereinafter, may be particularly referred to as “reception user”) U2 faces may be robot devices of the same type, and may have respective configurations that are the same as each other. Although FIG. 5 illustrates the transmission user U1 and the reception user U2 as users different from each other, both the users U1 and U2 may be an identical user. The transmission user U1 corresponds to a “first user” according to the present embodiment, and the reception user U2 corresponds to a “second user” according to the present embodiment.

Further, in the present embodiment, a response to an action or an input performed by the transmission user U1 is performed by the cooperating robot device 2 and the cooperating devices 201 to 203 that are different from the robot device 1B. The robot device 1B and the cooperating robot device 2 may be disposed in one room or in different rooms of one building, or may be disposed in places away from each other, for example, in different buildings. The cooperating devices 201 to 203 may likewise be located, relative to the cooperating robot device 2, in one room or in different rooms of one building, or may be disposed in a place away from the cooperating robot device 2, such as in different buildings. The robot device 1B and the cooperating robot device 2 may be configured to communicate with each other via wire or wirelessly.

The control system 101 may be built into the respective bodies 11 of the robot devices 1B and 2, or may be installed at a place other than the robot devices 1B and 2. In a case where the control system 101 is built into the respective bodies 11 of the robot devices 1B and 2, the control system 101 may have respective functions of the input acceptor 111, the expression content decider 121, and the signal generator 131 (FIG. 2) collectively in one of the robot device 1B or 2, or may have the respective functions distributed between both the robot devices 1B and 2. In addition, the control system 101 may be disposed in a so-called cloud, and is coupled to both the robot devices 1B and 2 via the network N such as the Internet.

In addition, in the present embodiment, the user attribute identification unit 124 and the user situation determination unit 125 included in the expression content decider 121 of the control system 101 may identify an attribute of the transmission user U1 and may determine a situation in which the transmission user U1 is in, and may also identify an attribute of the reception user U2 and may determine a situation in which the reception user U2 is in.

For example, in a case where the control system 101 identifies the attribute of the transmission user U1, the control system 101 may change specific expression contents on the basis of the attribute of the transmission user U1 upon making a response to the reception user U2. Specifically, a response to an input performed by a grandchild serving as the transmission user U1 may be expressed to a grandparent serving as the reception user U2 with a sweet nuance or a cute nuance, and for example, a cute nuance may be added to the operation performed by the cooperating robot device 2 in such a manner that the body 11 wiggles to the left and right. In addition, the expression contents may be changed on the basis of whether the transmission user U1 is male or female. For example, in a case where the transmission user U1 is female, an utterance made by the robot device 2 may be changed to a higher tone.

In addition, in a case where the control system 101 identifies the attribute of the reception user U2, the control system 101 may change specific expression contents on the basis of the attribute of the reception user U2 upon making a response to the reception user U2. For example, in a case where the reception user U2 is an elderly person, the utterance made by the robot device 2 may be changed in such a manner as to be slower in speed, or may be increased in volume. As described above, it goes without saying that the reception user U2 having a visual disability may be provided with an expression focused on an utterance, and the reception user U2 having a hearing disability with an expression focused on a message.

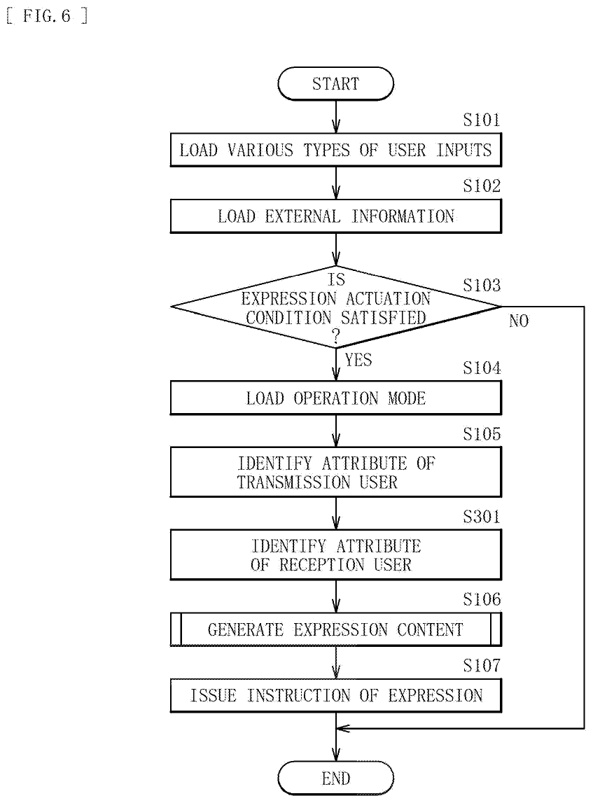

FIG. 6 is a flowchart illustrating a basic operation of the control system 101 of the robot device 1B according to the present embodiment.

Only the differences from the operation illustrated in the flowchart of FIG. 3 will be described. In the present embodiment, after the attribute of the transmission user U1 is identified in S105, the attribute of the reception user U2 is identified in S301. Thereafter, in S106, referring to the attribute of the transmission user U1 and the attribute of the reception user U2, the expression content is decided. In S107, a control signal corresponding to the decided expression content is generated.

According to the present embodiment, it becomes possible to make a more appropriate response expression to the reception user U2 who is different from the transmission user U1 who performs an action on the robot device 1A.

### 3. THIRD EMBODIMENT

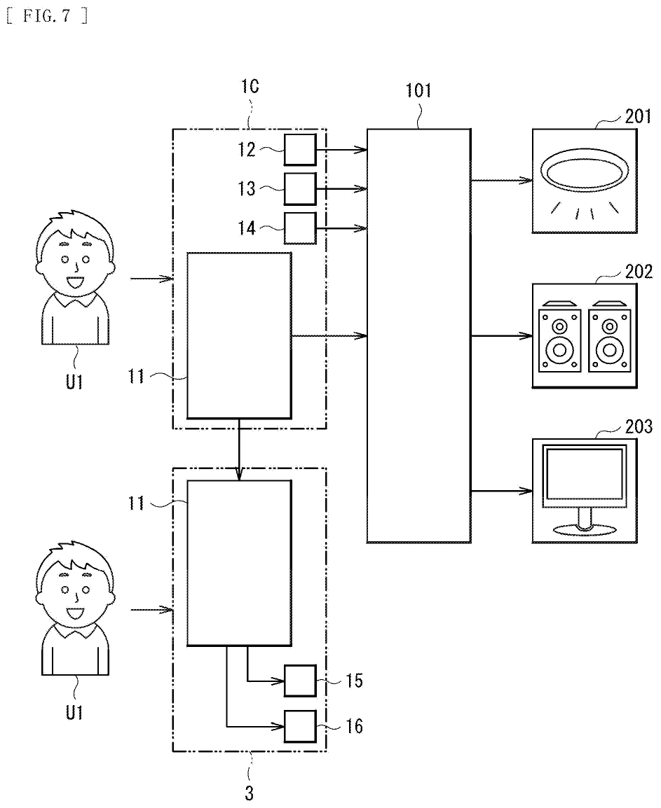

FIG. 7 is a schematic diagram illustrating a configuration of a robot device 1C according to a third embodiment of the present disclosure, and illustrates a relationship with other devices 3 and 201 to 203 cooperable with the robot device 1C.

The present embodiment employs the robot device (a cooperating robot device) 3 that is able to interact with a robot device 1C, in addition to the lighting device 201, the acoustic device 202, and the display device 203 each serving as a cooperating device that is another device other than the robot device 1C. The interaction between the robot device 1C and the cooperating robot device 3 may be performed by wireless or wired communication, or may be performed by a medium such as a voice that the user U1 is recognizable. It is also possible that the cooperating robot device 3 is configured to interact with the user U1 as with the robot device 1C.

In the present embodiment, in a case where the user U1 performs an action on the robot device 1C, and where it is difficult to make a response, i.e., to decide an expression content, depending on the robot device 1C and the control system 101 included therein, or the decision necessitates confirmation, the robot device 1C makes an inquiry to the cooperating robot device 3. The inquiry may be in any mode; however, in the present embodiment, the user U1 makes an inquiry by a voice serving as a medium recognizable by the user U1. The inquiry made by the robot device 1C to the cooperating robot device 3 corresponds to an “instruction signal” according to the present embodiment. Upon detecting the inquiry, the cooperating robot device 3 interprets the content and makes a response to the user U1 on behalf of the robot device 1C.

For example, in response to the question “How high is the Tokyo Sky Tree?” that the user U1 asked to the robot device 1C, the robot device 1C outputs the voice saying, as the utterance to the user U1, “I'll ask Mr. XX”, and asks the cooperating robot device 3 “Mr. XX, how high is the Tokyo Sky Tree?”. In response, the cooperating robot device 3 answers “The height of the Tokyo Sky Tree is 634 m” which is a response to be made by the robot device 1C with respect to the question given by the user U1.

The question to be asked by user U1 to the robot device 1C corresponds to an “input to the robot device” according to the present embodiment, and the utterance to be made by the robot device 1C and the answer to be made by the cooperating robot device 3 with respect to the question each correspond to a “response” according to the present embodiment.

In this way, with respect to the input performed by the user U1, the robot device 1C and the cooperating robot device 3 make it possible to express the response in cooperation with each other. This makes it possible to make the response more accurately and diversifies the expression as compared with a case where the robot device 1C alone makes the response.

### 4. CONCLUSION

Embodiments of the present the present disclosure have been described above with reference to the drawings. According to the embodiments of the present disclosure, it becomes possible that the robot device itself make an expression beyond the expressible range, and that the robot device appropriately making a response expression, thereby improving the influence on the user experience (UX).

In addition, not all of the configuration and the operation described in the above embodiments are indispensable as the configuration and the operation of the present disclosure. For example, among the components in the above-described embodiments, components not described in the independent claims indicating the most significant concepts of the present disclosure are to be understood as optional components.

The terms used throughout this specification and the appended claims should be construed as “non-limiting” terms. For example, the term “comprising” or “being comprised” should be construed as “not being limited to the mode recited as being comprised”. The term “including” should be construed as “not being limited to the mode recited as being included”.

The terms used herein are used merely for convenience of explanation and include terms that are not used to limit the configuration and operation. For example, the terms “right”, “left”, “top”, “bottom”, and the like each merely indicate a direction on the drawing being referred to. Further, the terms “inner side” and “outer side” each indicate a direction toward the center of an element of interest and a direction away from the center of the element of interest, respectively. The same applies to terms similar to these terms and terms having similar meaning.

It is to be noted that the technology according to the present disclosure may have the following configurations. According to the technology of the present disclosure having the following configurations, it is possible to provide the robot device and the information processing device that are able to appropriately make the response expression to the input. Effects according to the technology of the disclosure are not necessarily limited to those described herein. The present disclosure may further include any effects other than those described herein.

(1)

A robot device including:
an input acceptor configured to accept an input to a robot device;
an expression content decider configured to decide a set of expression contents in which the expression contents are associated with each other, the expression contents each indicating a response of the robot device with respect to the input; and
the signal generator configured to generate an instruction signal that causes another device other than the robot device to execute an operation corresponding to one portion out of the set of expression contents.
   (2)

The robot device according to (1), further including
an operation control unit configured to generate a control signal that causes the robot device to execute an operation corresponding to another portion out of the set of expression contents other than the one portion.
   (3)

The robot device according to (2), in which the operation corresponding to the other portion involves a variation in an attitude, an orientation, or a position of the robot device.

(4)

The robot device according to any one of (1) to (3), in which the input is an input performed by a user.

(5)

The robot device according to (4), in which the expression contents in the set of expression contents are associated with each other, the expression contents each serving to represent an emotion that the robot device holds.

(6)

The robot device according to (4), in which the expression contents in the set of expression contents are associated with each other, the expression contents each serving to reflect an emotion of the user that the robot device grasps via the input.

(7)

The robot device according to any one of (1) to (3), in which the input is an input made through a path other than an interaction between the robot device and a user.

(8)

The robot device according to (7), in which the expression contents in the set of expression contents may be associated with each other, the expression contents each serving to present a situation in which the user is in.

(9)

The robot device according to (8), in which the set of expression contents includes an alarm.

(10)

The robot device according to any one of (1) to (9), further including a user attribute identification unit configured to identify an attribute of a user, in which
the expression content decider changes the expression content on a basis of the attribute.
   (11)

The robot device according to (10), in which
the input is an input performed by a first user,
a user who receives an expression made by the other device is a second user who is different from the first user, and
the user attribute identification unit identifies an attribute of the first user.
   (12)

The robot device according to (10), in which
the input is an input performed by a first user,
a user who receives an expression made by the other device is a second user who is different from the first user, and
the user attribute identification unit identifies an attribute of the second user.
   (13)

The robot device according to any one of (1) to (11), further including an operation mode setting unit configured to set an operation mode of the robot device, in which
the expression content decider changes the expression content on a basis of the operation mode.
   (14)

The robot device according to any one of (1) to (13), in which the signal generator generates, as the instruction signal, an inquiry with respect to the other device.

(15)

The robot device according to (14), in which the inquiry is made by a voice.

(16)

An information processing device including:
an input acceptor configured to accept an input to a robot device;
an expression content decider configured to decide a set of expression contents in which the expression contents are associated with each other, the expression contents each indicating a response with respect to the input;
the signal generator configured to generate an instruction signal that causes another device other than the robot device to execute an operation corresponding to one portion out of the set of expression contents; and
an operation control unit configured to generate a control signal that causes the robot device to execute an operation corresponding to another portion out of the set of expression contents other than the one portion.

This application claims the benefit of Japanese Priority Patent Application JP2020-162193 filed with the Japan Patent Office on Sep. 28, 2020, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A robot device comprising:
an input acceptor configured to accept an input to a robot device;
an expression content decider configured to decide a set of expression contents in which the expression contents are associated with each other, the expression contents each indicating a response of the robot device with respect to the input; and
the signal generator configured to generate an instruction signal that causes another device other than the robot device to execute an operation corresponding to one portion out of the set of expression contents.

2. The robot device according to claim 1, further comprising
an operation control unit configured to generate a control signal that causes the robot device to execute an operation corresponding to another portion out of the set of expression contents other than the one portion.

3. The robot device according to claim 2, wherein the operation corresponding to the other portion involves a variation in an attitude, an orientation, or a position of the robot device.

4. The robot device according to claim 1, wherein the input is an input performed by a user.

5. The robot device according to claim 4, wherein the expression contents in the set of expression contents are associated with each other, the expression contents each serving to represent an emotion that the robot device holds.

6. The robot device according to claim 4, wherein the expression contents in the set of expression contents are associated with each other, the expression contents each serving to reflect an emotion of the user that the robot device grasps via the input.

7. The robot device according to claim 1, wherein the input is an input made through a path other than an interaction between the robot device and a user.

8. The robot device according to claim 7, wherein the expression contents in the set of expression contents may be associated with each other, the expression contents each serving to present a situation in which the user is in.

9. The robot device according to claim 8, wherein the set of expression contents includes an alarm.

10. The robot device according to claim 1, further comprising a user attribute identification unit configured to identify an attribute of a user, wherein
the expression content decider changes the expression content on a basis of the attribute.

11. The robot device according to claim 10, wherein
the input is an input performed by a first user,
a user who receives an expression made by the other device is a second user who is different from the first user, and
the user attribute identification unit identifies an attribute of the first user.

12. The robot device according to claim 10, wherein
the input is an input performed by a first user,
a user who receives an expression made by the other device is a second user who is different from the first user, and
the user attribute identification unit identifies an attribute of the second user.

13. The robot device according to claim 1, further comprising an operation mode setting unit configured to set an operation mode of the robot device, wherein
the expression content decider changes the expression content on a basis of the operation mode.

14. The robot device according to claim 1, wherein the signal generator generates, as the instruction signal, an inquiry with respect to the other device.

15. The robot device according to claim 14, wherein the inquiry is made by a voice.

16. An information processing device comprising:
an input acceptor configured to accept an input to a robot device;
an expression content decider configured to decide a set of expression contents in which the expression contents are associated with each other, the expression contents each indicating a response with respect to the input;
the signal generator configured to generate an instruction signal that causes another device other than the robot device to execute an operation corresponding to one portion out of the set of expression contents; and
an operation control unit configured to generate a control signal that causes the robot device to execute an operation corresponding to another portion out of the set of expression contents other than the one portion.
